(19) United States
(12) Patent Application Publication
(10) Pub. No.: US 2003/0203164 A1
(43) Pub. Date: Oct. 30, 2003

(54) Anti-fatigue mat

(75) Inventors: Patrick E. Healy, Gallitzin, PA (US); R. Douglas Evans JR., Everett, PA (US); Raymond L. Fedeli, Altoona, PA (US); Heidi G. Shetler, Altoona, PA (US)

Correspondence Address: Bryan H. Opalko, Esquire, Buchanan Ingersoll, P.C., One Oxford Centre, 20th Floor, 301 Grant Street, Pittsburgh, PA, 15219, US

(73) Assignee: New Pig Corporation, Tipton, PA (US)

(21) Appl. No.: 10/447,480

(22) Filed: May 28, 2003

Related U.S. Application Data
(63) Continuation-in-part of application No. 10/116,283, filed on Apr. 4, 2002.

(51) Int. Cl. B32B 1/00

(52) U.S. Cl. 428/178; 428/354; 428/43

(57) ABSTRACT

An anti-fatigue mat is provided having a layer of absorbent material attached face-to-face to a layer of cushioning material. The layer of absorbent material has liquid absorbent properties, while the layer of cushioning material has shock absorption properties and is preferably liquid impermeable. While the layer of cushioning material may inherently have some liquid absorbent properties, its primary function is for shock absorption. The layer of absorbent material includes top and bottom surfaces, with the layer of cushioning material attached to the bottom surface of the layer of absorbent material. In one form, since the inventive mat may incur moderate to high foot traffic, a layer of wear-resistant material is attached to the top surface of the layer of absorbent material to increase the useful life of the inventive mat. Alternately, the top surface of the layer of absorbent material may have wear-resistant properties, or the layer of absorbent material may be manufactured to have higher wear characteristics, to increase the useful life of the mat.

### CROSS-REFERENCE TO RELATED APPLICATIONS

The present application is a continuation-in-part of application Ser. No. 10/116,283 entitled “Absorbent/Cushion Sheet Product”, filed on Apr. 4, 2002, the entire disclosure of which is incorporated by reference herein.

### FIELD OF THE INVENTION

The present invention is directed toward mats in general and, more particularly, toward an anti-fatigue mat having both absorbent and cushioning properties.

### BACKGROUND OF THE INVENTION

It is essential that managers and workers in settings where there exists a potential for leaks or spills of toxic and/or non-toxic liquids be prepared to contain the leaks or cleanup the spills. A number of products have been developed for absorbing liquids from leaks and spills. Typically, each product is directed to a specific type of problem. For example, leaks, splashes and drips of a slippery liquid over a walkway may be addressed by a walk-on mat that absorbs the liquid and has an upper surface that is resistant to the wear of foot traffic. These walk-on mat products may also be used in non-traffic areas as absorbent pads. Puddles of liquid are often cleaned up by throwing absorbent response pads or pillows on the puddle. The outward flow of a leak or spill is often contained by placing an absorbent sock around the outer edges of the liquid to soak up the liquid as it reaches the sock. Drips and sprays are typically absorbed from surfaces with absorbent wipes.

Absorbent mats, in addition to being utilized to clean up spills in high traffic areas, may also be utilized around work stations in basically a defensive fashion. Absorbent mats provided around work stations are designed to catch spills or drips that may occur at the work station in an effort to prevent a potentially dangerous situation. Such absorbent mats may be utilized at a single work station, or cover an entire floor area. In addition to having absorbent properties, absorbent mats provided by work stations and other high foot traffic areas will typically include a wear resistant surface in order to increase the useful life of the absorbent mat. Such mats are also typically made to be disposable, in that once the absorbent mat has become fully saturated or sufficiently worn such that it has reached its useful life span, it may be easily replaced with a new mat.

Absorbent mats provided around work stations will particularly receive a moderate to high amount of traffic, since an individual working at the work station is typically standing on the mat for the better part of the work day. The absorbent mat, in addition having absorbent properties, must provide a slip-resistant surface upon which an individual may walk or stand. Since an individual standing all day at a work station will be subject to fatigue, it would advantageous if the absorbent mat, in addition to having absorbent properties, could have properties that would assist in alleviating the fatigue associated with a worker standing all day thereon.

The present invention is directed toward overcoming one or more of the above-mentioned problems.

### SUMMARY OF THE INVENTION

An anti-fatigue mat is provided, according to the present invention, having a layer of absorbent material attached face-to-face to a layer of cushioning material. The layer of absorbent material has liquid absorbent properties, while the layer of cushioning material has shock absorption properties and is preferably liquid impermeable. While the layer of cushioning material may inherently have some liquid absorbent properties, its primary function is for shock absorption. The layer of absorbent material includes top and bottom surfaces, with the layer of cushioning material attached to the bottom surface of the layer of absorbent material. In one form, since the inventive mat may incur high foot traffic, a layer of wear-resistant material is attached to the top surface of the layer of absorbent material to increase the useful life of the inventive mat. Alternately, the top surface of the layer of absorbent material may have wear-resistant properties to increase the useful life of the mat.

The layer of cushioning material has an exposed surface which may include an adhesive material thereon for adhering the inventive mat to a surface and prevent it from slipping when walked upon. The adhesive material will prevent the mat from slipping, and is particularly useful when the mat is placed at a work station, with an individual standing on the mat and working at the work station most of the work day. In one form, the adhesive material includes double-sided tape provided on the exposed surface of the layer of cushioning material.

The anti-fatigue mat according to the present invention may include additional layers of absorbent material and/or wear-resistant material attached to the exposed surface of the layer of cushioning material. In this particular construction, the inventive mat may be considered reversible having layers of absorbent material provided on either side of the layer of cushioning material. Further, an additional layer of cushioning material may be provided either adjacent to the initial layer of cushioning material or attached to one of the layers of absorbent material, such that the inventive mat may include an absorbent-cushion-cushion-absorbent layered construction, or an absorbent-cushion-absorbent-cushion layered construction. An adhesive material may be provided on an exposed surface of the mat to adhere the mat to a surface and prevent it from slipping when walked upon.

The layer of absorbent material may include virtually any material having liquid absorbent properties. In one form, the layer of absorbent material includes a layer of foam material having an open cell construction. In another form, the layer of absorbent material includes a layer of woven or nonwoven liquid absorbing fabrics. In yet another form, the layer of absorbent material includes a layer of meltblown microfibrous materials. The layer of meltblown microfibrous materials may include a plurality of sublayers of meltblown microfibrous materials bonded together utilizing conventional bonding techniques.

Similarly, the layer of cushioning material may include virtually any material having shock absorption properties. In one form, the layer of cushioning material includes a layer of foam material having a closed cell construction. In another form, the layer of cushioning material includes a layer of bubble wrap, which includes a plurality of sealed air pockets or cavities. While the cavities formed in the bubble wrap are typically filled with air, the cavities may be filled with any material that exhibits shock absorption properties when pressure is applied to the mat, such as, but not limited to, resilient materials, gelatinous materials, viscous materials, non-compressible liquids, etc.

The layer of absorbent material and the layer of cushioning material may be attached face-to-face by a variety of methods including, but not limited to, stitching, sewing, stapling, gluing, hot melt bonding, pin bonding, ultrasonic bonding, mechanical bonding and thermal bonding the layers together.

The layer of absorbent material may overlap the layer of cushioning material, such that the layer of cushioning material does not extend all the way to the edges of the inventive mat. In this form, the peripheral edges of the mat will be sloped downward defining a ramp-like edge portion permitting dollies and other similar wheeled devices to be easily rolled across the mat.

In another form, the inventive anti-fatigue mat includes two absorbent layers joined together, face to face, at all but one edge thereof to define a pocket between the absorbent layers. Cushioning material, which may include one or more layers of cushioning material or a plurality of pieces of cushioning material, may be removably inserted into the pocket. Additionally, further absorbent materials may also be inserted into the pocket. In this form, the absorbent and cushioning properties of the mat are readily adjustable.

In a further form, the anti-fatigue mat is provided in conjunction with a tray member which may be made of a hard polyethylene or rubber-like material. The tray includes a center receptacle portion having the same geometric configuration as that of the mat. The edges of the tray are sloped downward to form a ramp, such that dollies and other similar wheeled devices may be easily rolled across the mat/tray combination.

In an additional form of the inventive anti-fatigue mat, the mat is provided in a rolled or folded form. In this form, the mat is in the form of a long strip with two substantially parallel edges. The long strip is provided with perforations extending substantially perpendicular to the strip edges enabling: a) the long strip to be torn apart along the perforations into individual anti-fatigue, walk-on mats, and b) the long strip to be folded along the perforations. The individual anti-fatigue, walk-on mats may include additional perforations enabling them to be torn into portions.

The inventive mat finds particular utility as a walk-on mat provided in areas with high foot traffic. The inventive mat is designed to provide all day comfort for standing employees, relieving fatigue throughout the day while additionally including absorbent properties to absorb any spills that may occur. The inventive mat is particularly useful when provided at or around a work station at which an individual typically stands for most of the day while working at the work station. The inventive mat will absorb any spills that may occur, while helping to protect the worker from the effects of fatigue that results from continuous standing.

It is an object of the present invention to provide an anti-fatigue mat having both absorbent and cushioning characteristics.

It is a further object of the present invention to provide an anti-fatigue mat that may be die cut into a plurality of shapes to suit particular applications.

It is yet a further object of the present invention to provide an anti-fatigue mat which will maintain the majority of its cushioning properties upon becoming saturated with liquid.

It is still a further object of the present invention to provide an anti-fatigue mat that may be provided at a work station having both absorbent properties and properties to help protect individuals standing thereon from the effects of fatigue.

Other aspects, objects and advantages of the present invention can be obtained from a study of the application, the drawings, and the appended claims.

### BRIEF DESCRIPTION OF THE DRAWINGS

FIG. 1 is a perspective view of the anti-fatigue mat according to the present invention;

FIG. 2 is a bottom view of the anti-fatigue mat according to an additional embodiment of the present invention;

FIG. 3 is a partial cross-sectional view taken along line 3-3 in FIG. 2 with the anti-fatigue mat in an upright position;

FIGS. 4-5 are partial cross-sectional views of alternate constructions of the inventive anti-fatigue mat;

FIG. 6 is a partial cross-sectional view taken along line 6-6 in FIG. 2 with the anti-fatigue mat in an upright position;

FIG. 7 is a perspective view of a modified form of the inventive anti-fatigue mat;

FIG. 8 is a top view of the anti-fatigue mat according to the present invention provided in a tray;

FIG. 9 is a partial cross-sectional view taken along line 9-9 in FIG. 8;

FIG. 10 is a top view of an additional modified form of the anti-fatigue mat of the present invention provided in a tray;

FIG. 11 is a perspective view of the anti-fatigue mat of the present invention provided as a long strip;

FIG. 12 is a side view of the anti-fatigue mat of the present invention provided as a long strip and folded into a continuous stack for storage and use; and

FIG. 13 is a side view of the anti-fatigue mat of the present invention provided as a long strip and rolled into a roll for storage and use.

### DETAILED DESCRIPTION OF THE INVENTION

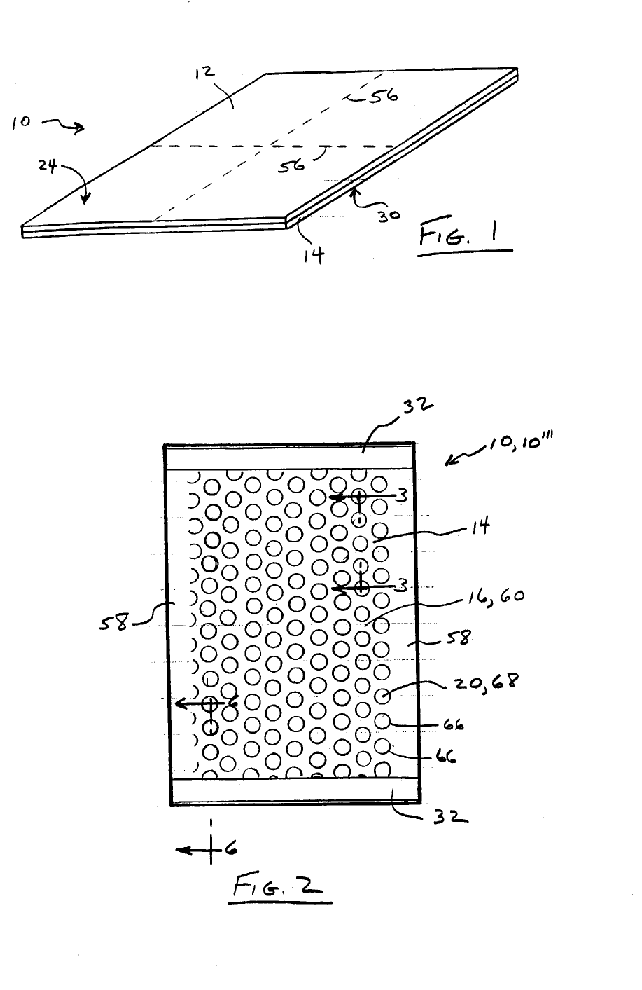

Referring to FIG. 1, an anti-fatigue mat according to the present invention is shown generally at 10. In its broadest form, the inventive mat 10 includes a layer of absorbent material 12 attached face-to-face to a layer of cushioning material 14. The layer of absorbent material 12 has liquid absorbent properties, while the layer of cushioning material 14 has shock absorption properties. The inventive mat 10 is typically provided as a walk-on mat for absorbing spills in high foot traffic areas, however, this particular use is exemplary only and other uses of the inventive mat 10 are contemplated.

While the layer of cushioning material 14 is preferably liquid impermeable, it may inherently have some liquid absorbent properties. However, the absorbency of the cushioning material 14 will be minimal compared to the absorbent properties of the absorbent material 12. The primary function of the layer of cushioning material 14 is for its shock absorption characteristics.

The absorbent layer 12 and the cushioning layer 14 are attached face-to-face by gluing via an adhesive (not shown) provided between the layers 12 and 14. However, other methods may be employed to attach the absorbent 12 and cushioning 14 layers face-to-face without departing from the spirit and scope of the present invention. Such methods include, but are in no way limited to, stitching, sewing, stapling, hot melt bonding, pin bonding, ultrasonic bonding, mechanical bonding and thermal bonding the absorbent 12 and cushioning 14 layers together.

The layer of absorbent material 12 may include virtually any material having liquid absorbent properties. One such material that may be utilized for the absorbent layer 12 is a foam material having an open cell construction, and, thus, liquid absorbent properties. While the absorbent layer 12 may be made from any material having liquid absorbent properties, in a preferred form, the absorbent layer 12 is made from microfibrous sheet materials, including meltblown microfibers. The absorbent layer 12 may include any woven or nonwoven liquid absorbing fabrics made from natural materials, such as cellulose, wool, etc., and man-made materials, such as polyolefins, polyesters, nylons, glass, etc., or any other related materials in any combination that would allow the absorbent layer 12 to be used to clean, absorb, dike, contain, filter fluids or vapors and/or provide a wear-resistant working surface. In addition, the absorbent layer 12 could be hydrophilic or hydrophobic as required by a particular in use application. Component webs that are naturally hydrophobic can be treated with various surfactants to make them hydrophilic, either by surface application and/or by incorporation of the surfactant into the molten polymer stream prior to the nonwoven web forming processing or, or in the case of woven webs, prior to the production yards, filaments, etc. For webs that are naturally hydrophilic, surface application of various additives, such as silicon-based products, can be used to make the webs hydrophobic. Particular end use applications may dictate the need for other characteristics, such as, ultraviolet light resistance, fire resistance, static resistance, and various colors or tints, etc. These and other characteristics known to those skilled in the art can be achieved by surface application and/or by direct polymer addition to the absorbent layer 12. Additionally, when a layer of meltblown microfibrous materials is utilized for the absorbent layer 12, the layer of meltblown microfibrous materials may include a plurality of sublayers of meltblown microfibrous materials bonded together utilizing conventional bonding techniques, including, but not limited to, needlepunching, stitchbonding, meltblowing, spunbonding, and the like.

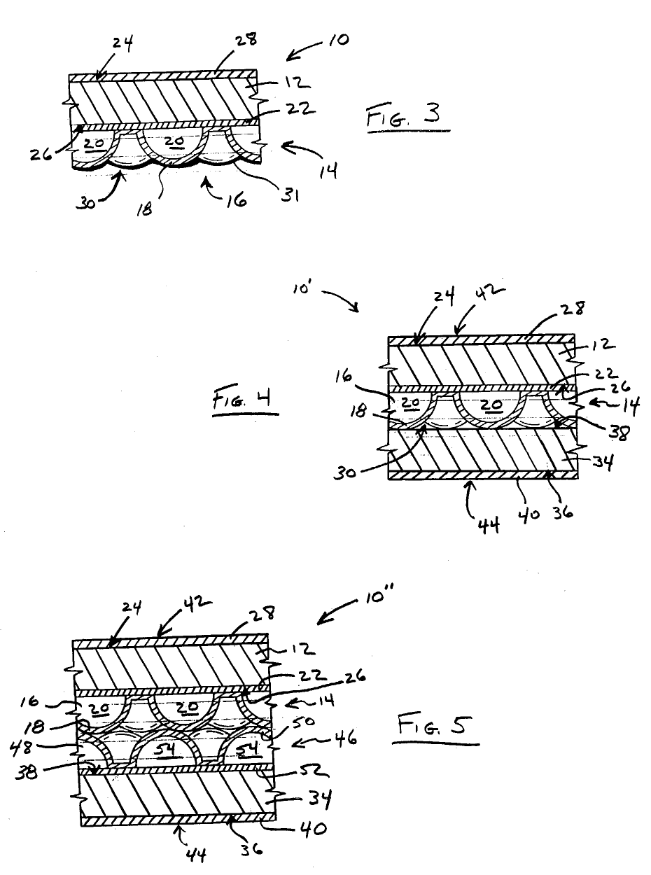

The layer of cushioning material 14 may include virtually any material having shock absorption properties and preferably being liquid impermeable. One such material that may be utilized for the cushioning layer 14 includes a foam material having a closed cell construction, thus having minimal liquid absorbent properties or being liquid impermeable. As shown in FIGS. 2-3, in a preferred form, the cushioning layer 14 includes bubble wrap, shown generally at 16. The bubble wrap 16 includes a first thin flexible layer 18 of plastic material, e.g., polyethylene, polypropylene, etc., having a plurality of spaced apart cavities or recesses 20 in one surface thereof. Typically, the cavities 20 are of a hemispherical shape, but other cavity 20 shapes are contemplated. Additionally, the bubble wrap 16 includes a second thin flexible layer 22 of plastic material, e.g., polyethylene, polypropylene, etc., which is bonded to the one surface of the first layer 18 in order to seal air into the cavities 20. The absorbent layer 12 is attached to the second layer 22 of the bubble wrap 16 via an adhesive (not shown). However, any of the previously described methods may be employed to attach face-to-face the absorbent layer 12 to the bubble wrap 16. Further, the absorbent layer 12 need not be attached to the second layer 22 of the bubble wrap 16, but may be attached to the first layer 18 of the bubble wrap 16 without departing from the spirit and scope of the present invention.

The cavities 20 in the bubble wrap 16 serve to define hemispherical pockets of air. The cavities 20 may, of course, be other than hemispherical. Further, both the first 18 and second 22 layers may additionally be provided with cavities to provide bubbles on both sides of the bubble wrap 16 without departing from the spirit and scope of the present invention. While the cavities 20 are typically filled with air, the cavities 20 may be filled with any material exhibiting shock absorption properties when pressure is applied to the mat 10. Such materials may include, but are not limited to, resilient materials that resume their original shape after being compressed, such as sponge-like materials, soft urethane materials, etc., gelatinous materials, viscous materials, and non-compressible liquids, such as water and the like.

As shown more particularly in FIG. 3, the layer of absorbent material 12 includes top 24 and bottom 26 surfaces. A layer of wear-resistant material 28 is attached to the top surface 24 of the layer of absorbent material 12 via any of the previously described attachment methods. While the layer of wear-resistant material 28 may include some liquid absorbent properties, its primary purpose is to provide a wear-resistant surface for the mat 10 to increase the useful lifespan of the mat 10 when used in high foot traffic areas. Alternately, instead of providing the layer of wear-resistant material 28, the top surface 24 of the layer of absorbent material 12 may include wear-resistant properties, or the layer of absorbent material 12 itself may be manufactured to have a higher wear characteristics throughout. Two examples of providing such higher wear characteristics include manufacturing the layer of absorbent material 12 utilizing stitchbonding and/or needlepunching techniques, however, other methods are contemplated.

The layer of cushioning material 14 includes an exposed surface 30 typically provided against the floor or other surface on which the mat 10 is to be used. The exposed surface 30 of the layer of cushioning material 14 typically includes an adhesive material 31 provided thereon for adhering the mat 10 to a surface and preventing the mat from slipping when walked upon. Preventing the mat 10 from slipping is particularly a safety concern where the mat 10 is provided in a high foot traffic area. The adhesive material 31 may be spread over the entire exposed surface 30 of the layer of the cushioning material 14 as shown in FIG. 3 or, as shown specifically in FIG. 2, may include strips of double-sided tape 32 provided along opposing edges of the mat 10. It should be understood that the adhesive material 31 and/or the double-sided tape 32 may be provided on the wear-resistant layer 28 or, alternately, on the top surface 24 of the layer of absorbent material 12 if the wear-resistant layer 28 is omitted. In this particular form, the layer of absorbent material 12 would be situated against the floor or other surface, with the layer of cushioning material 14 receiving the foot traffic. If this particular orientation of the mat 10 is desired, the layer of cushioning material 14 may have a layer of wear-resistant material (not shown) attached to its exposed surface 30.

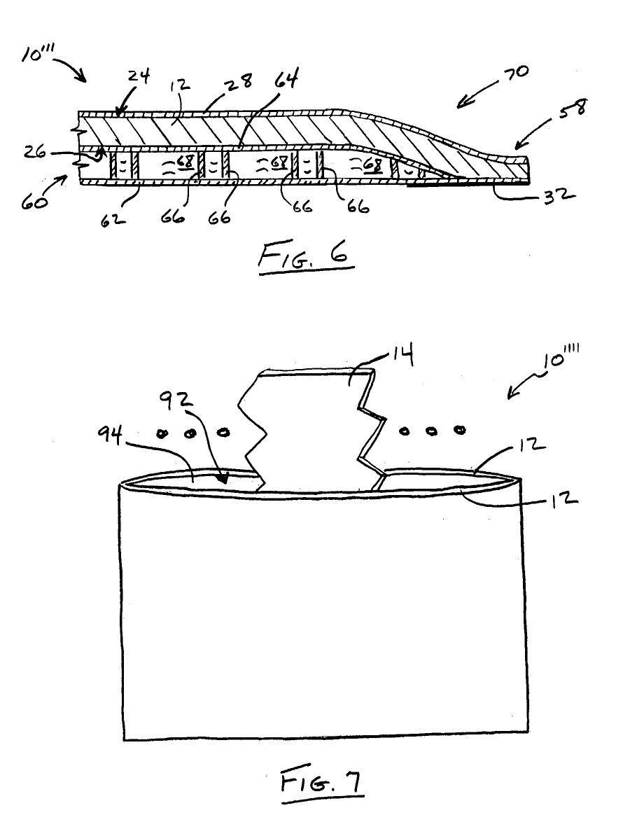

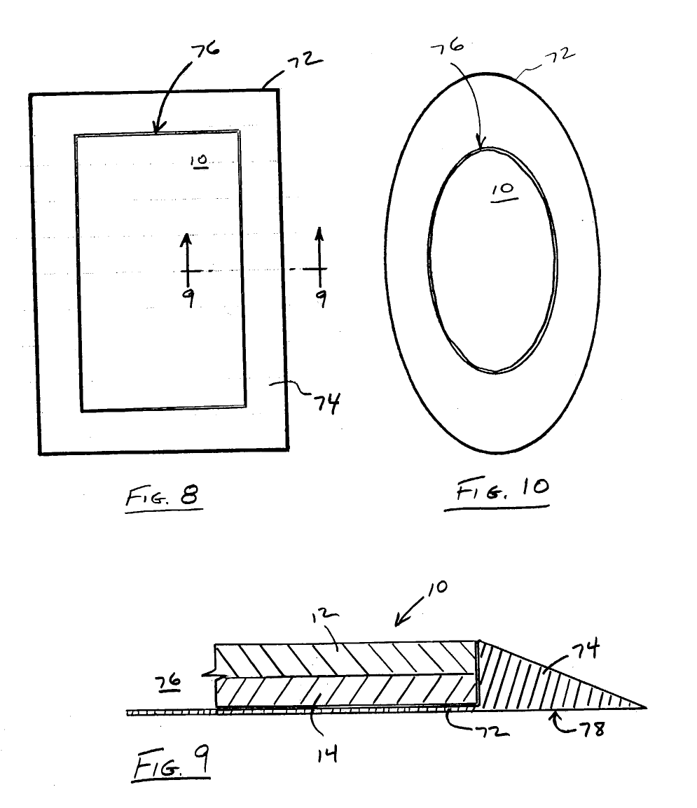

FIGS. 4-5 illustrate alternate constructions of the mat 10, with like elements of FIG. 3 indicated with the same reference number. As shown in FIG. 4, an additional layer of absorbent material 34 may be attached to the layer of cushioning material 14 at the exposed surface 30 thereof. Attachment of the additional layer of absorbent material 34 to the layer of cushioning material 14 may be accomplished via any of the previously described methods of attachment. The additional layer of absorbent material 34 includes top 36 and bottom 38 surfaces, similar to the layer of absorbent material 12. The bottom surface 38 of the additional layer of absorbent material 34 is attached to the layer of cushioning material 14. A wear-resistant layer 40 is attached to the top surface 36 of the additional layer of absorbent material 34. The wear-resistant layer 40 may be similar in construction to the wear-resistant layer 28 and have similar wear-resistant properties. Alternately, the top surface 36 of the additional layer of absorbent material 34 may include wear-resistant properties. Thus, with the mat 10′ construction shown in FIG. 4, the mat 10′ is essentially reversible with either exposed surface 42 or 44 serving as the top surface of the mat 10′. The double-sided tape 32, or other adhesive material 31, may be provided on the appropriate surface 42 or 44 which will be placed against the floor or other surface.

As shown in FIG. 5, an additional layer of cushioning material 46 may be provided between the layers of absorbent material 12 and 34. In the particular construction depicted in FIG. 5, the additional layer of cushioning material 46 is provided between the layer of cushioning material 14 and the additional layer of absorbent material 34. The additional layer of cushioning material 46 includes a layer of bubble wrap 48 similar in construction to the bubble wrap 16 and including first 50 and second 52 thin flexible layers of plastic material bonded to one another to form air cavities 54. As previously described, the cavities 54 may be filled with air or any other materials as previously described exhibiting shock absorption properties when pressure is applied to the mat 10″. Attachment of the additional layer of cushioning material 46 to the layers 14 and 34 may be accomplished via any of the previously described attachment methods. Thus, the mat 10″ shown in FIG. 5 has added cushioning properties, while still being reversible in that either of the exposed surfaces 42 and 44 may be utilized as a top surface of the mat 10″. While the layers of bubble wrap 16 and 48 are shown in FIG. 5 as being attached face-to-face at their first layers 18 and 50, respectively, either or both of the layers of bubble wrap 16 and 48 may be reversed and attached at their other layers 22 and 52, respectively, without departing from the spirit and scope of the present invention. Further, while shown in FIG. 5 as bubble wrap 48, the additional layer of cushioning material 46 may include virtually any material having shock absorption properties and preferably being liquid impermeable.

It should be noted that the specific constructions illustrated in FIGS. 3-5 are for illustrative purposes only, and additional layers of absorbent and/or cushioning materials may be provided in alternating form, or consecutive form, without departing from the spirit and scope of the present invention. For example, the inventive anti-fatigue mat described herein may have various layered configurations without departing from the spirit and scope of the present invention. Some of the layered configurations may include, but are in no way limited to, absorbent-cushion-absorbent, cushion-absorbent-cushion, absorbent-cushion-cushion, absorbent-absorbent-cushion, absorbent-cushion-cushion-absorbent, absorbent-cushion-absorbent-cushion, etc., layered configurations. Any of the attachment methods previously described may be utilized to attach to the additional absorbent and/or cushioning layers to one another.

Further, as shown in FIG. 1, the mat 10 may be provided with perforations 56 which may extend across the mat 10 in a variety of directions. The perforations 56 enable the mat 10 to be torn into portions as desired for particular applications. As shown in FIG. 1, the perforations are die cut into the mat 10 in the form of a plus “+” sign, enabling the mat 10 to be torn into four portions. However, the perforations 56 may be die cut into any desired shape for particular applications, such as, but not limited to, diamonds, ovals, stars, circles, etc., without departing from the spirit and scope of the present invention.

As shown in FIGS. 2 and 6, the layer of cushioning material 14 is not provided at the peripheral edges of the mat 10, 10′″. As shown in FIG. 2, the layer of bubble wrap 16, 60 terminates before it reaches the edges of the mat 10, 10′″ such that the mat 10, 10′″ includes a peripheral edge 58 consisting of only the absorbent material 12. Preferably, as shown more clearly in FIG. 2, the double-sided tape 32 is provided along opposing peripheral edges 58 of the mat 10, 10′″.

FIG. 6, which is a partial cross-sectional view taken along line 6-6 in FIG. 2, illustrates an alternate embodiment of the layer of bubble wrap shown generally at 60. The layer of bubble wrap 60 includes spaced apart thin flexible layers 62 and 64 of plastic material, e.g., polyethylene, polypropylene, etc. Cylindrically shaped walls 66 of thin flexible plastic material extend between the layers 62 and 64, typically having a circular or oval cross-sectional shape, to form a plurality of air cavities 68 between the layers 62 and 64 and the walls 66. However, the walls 66 may have any geometric cross-sectional shape, such as hexagonal, square, etc., without departing from the spirit and scope of the present invention. As previously described, the cavities 68 may be filled with air or other materials exhibiting shock absorption properties when pressure is applied to the mat 10′″.

As shown more clearly in FIG. 6, the layer of absorbent material 12 essentially overlaps and extends beyond the layer of bubble wrap 60, such that the peripheral edge 58 of the mat 10′″ includes primarily absorbent material 12 only. As shown in FIG. 6, the layer of absorbent material 12 extends over the layer of bubble wrap 60 toward a floor surface, finally coming in contact with the floor surface at the peripheral edge 58. In this manner, the absorbent material 12 includes a sloped edge forming a ramp-like structure 70 at the peripheral edge portion 58 of the mat 10′″, such that dollies and other similar wheeled devices may be easily rolled over the mat 10′″. As shown in FIG. 6, the double-sided tape 32 is provided at the peripheral edge portion 58 of the mat 10′″. It should be understood that the particular construction shown in FIG. 6, in which the absorbent layer 12 forms a ramp-like structure 70 at the peripheral edge 58, may be utilized with any of the mat layered configurations described herein.

As shown in FIG. 7, the anti-fatigue mat of the present invention may be modified such that the cushioning layer is removable. As shown in FIG. 7, the inventive mat 10″″ includes two absorbent layers 12 joined together at all but one edge thereof to define a pocket 92 having an open end at 94. The cushioning layer 14 (a portion of which is shown in FIG. 7) may be inserted into the pocket 92 such that it is provided between the two absorbent layers 12. The open end 94 may be temporarily closed via snaps or Velcro® (not shown) or any other method of temporarily closing the open end 94 such that the cushioning layer 14 will not fall out of the pocket 92. In this modified form, different cushioning layers 14 having different cushioning properties may be readily incorporated into the inventive mat 10″″ to suit various applications. Further, while the inventive mat 10″″ shown in FIG. 7 is illustrated as rectangular in shape, the inventive mat 10″″ may take any geometric shape so long as an open end 94 is provided between the two absorbent layers 12 such that the cushioning layer 14 may be inserted therein.

As shown in FIGS. 8-9, the inventive anti-fatigue mat described herein may be provided in combination with a tray 72 providing the mat 10 with further reinforcement and preventing it from slipping. The tray 72 is typically made of a hardened polymer or rubber-like material and includes sloped, or ramped, peripheral edges 74 defining a receptacle 76 into which the mat 10 may be placed. The peripheral edges 74 of the tray 72 slope downward to form a ramped surface, such that dollies and other similar wheeled devices may be easily rolled over the tray/mat combination. The mat 10 is typically of the same geometry as that of the receptacle 76, with the two being sized substantially the same so that the mat 10 may be received in the receptacle 76 and substantially prevented from movement therein. In this particular embodiment, the cushioning material 14 may extend all the way out to the outer edges of the mat, since the tray 72 includes the ramped edges 74. The tray 72 includes a bottom surface 78, which may include adhesive material 31, double-sided tape 32, or inherently have non-skid properties to prohibit the tray/mat combination from moving.

While the tray/mat combination shown in FIG. 8 illustrates both the tray 72 and mat 10 having a rectangular shape, the tray 72 and mat 10 may take any geometrical shape without departing from the spirit and scope of the present invention. For example, as shown in FIG. 10, the tray 72 includes an oval shape defining an oval shaped receptacle 76, into which an oval shaped mat 10 is received. Thus, any geometric shaped tray 72 and mat 10 may be implemented within the spirit and scope of the present invention, and the tray 72 and mat 10 do not necessarily need to have the same geometric configuration. For example, a rectangular shaped tray 72 may be provided defining an oval shaped receptacle 76, into which an oval shaped mat 10 is received. As should be apparent to one skilled in the art, various combination are possible without departing from the spirit and scope of the present invention.

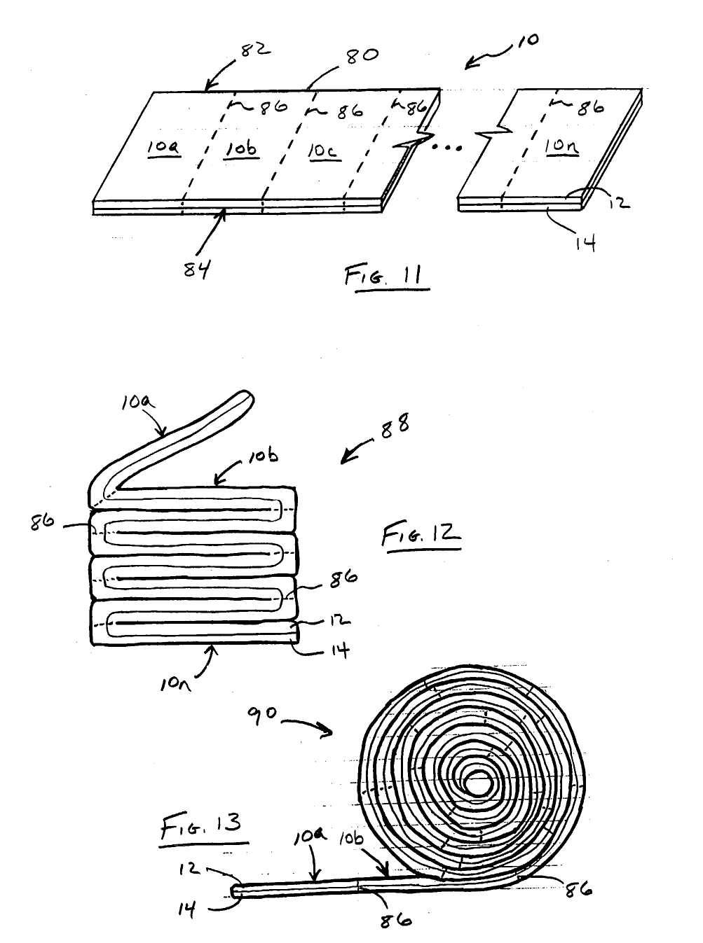

In an additional form of the present invention, as shown in FIGS. 11-13, the mat 10, which may include any of the previously described mat layered configurations, may be provided in a rolled or folded form. In this form, as shown in FIG. 11, the mat 10 is provided in the form of a long strip 80 having two substantially parallel edges 82 and 84. The long strip 80 is provided with perforations 86 extending substantially perpendicular to the strip edges 82 and 84. The perforations 86 define individual mats 10a-n which may be torn off of the long strip 80. As previously described, each of the individual mats 10a-n may include additional perforations enabling the individual mats 10a-n to be torn into portions as desired for particular applications.

As shown in FIG. 12, the perforations 86 enable the long strip 80 to be folded back and forth (as with an accordion or continuous form computer paper fold) to form a continuous stack 88. The continuous stack 88 may then be placed in an appropriate container for storage and use. One such appropriate container includes a slot through which a free end of the continuous stack 88 is payed out, such that a user may grasp and tear off one or more individual mats 10a-n for use.

Further, as shown in FIG. 13, the long strip 80 may be wound into a roll 90. The roll 90 may also be placed in an appropriate container for storage and use. One such container includes a slot through which the long strip 80 may be payed off of the roll 90 for the removal of one or more individual mats 10a-n for use.

As described herein, an inventive mat is provided having anti-fatigue properties. The inventive mat is designed not only to absorb liquids, but also to provide a cushioning effect when walked upon. The absorbent properties of the inventive mat will help eliminate a hazardous condition by absorbing various liquids from spills, drips, sprays, etc. that may occur in various environments. The inventive mat has particular utility when provided at a work station at which an individual typically stands for most of the day while working at the work station. The inventive mat provides a worker with a comfortable platform on which to stand, and the resilient properties of the cushioning layer helped to relieve fatigue throughout the day. The cushioning and resilient feature of the inventive mat encourages frequent, yet subtle changes in posture which, in turn, enhance circulation resulting in better comfort for an individual standing thereon. When the mat is providing at a work station, the comfort provided by the inventive mat helps to enhance worker productivity and morale, while providing durable and safe footing for the employee.

Since the inventive mat described herein has particular utility when provided at or around work stations, as well as other high foot traffic areas, the inventive mat must be made durable enough to withstand high foot traffic and thick enough to exhibit requisite absorbent and cushioning properties. For example, for most uses, the inventive mat may be sized approximately 50-60″×32-36″ and include layers of absorbent and cushioning material, each approximately ⅜-⅝″ thick. Additionally, when bubble wrap is provided as the cushioning layer, the bubble wrap should be made of a strong plastic material, possibly nylon reinforced plastic, in order to withstand the forces associated with persons walking and standing on the mat. The sizes of the pockets, or cavities, of the bubble wrap may also be varied in order for the inventive mat to exhibit different cushioning characteristics. However, as will be appreciated by one of ordinary skill in the art, the inventive mat described herein may be of any size, shape and/or thickness to suit particular applications without departing from the spirit and scope of the present invention. For example, while the inventive anti-fatigue mat has been described herein as a walk-on mat for areas with moderate to high foot traffic, the inventive anti-fatigue mat may be made to virtually any size, shape and/or thickness to suit a multitude of particular needs, such as, but not limited to, lay-on mats, kneel-on mats, sit-on mats, etc.

Various layered constructions of the inventive mat have also been described herein. However, these particular constructions are by no means exhaustive, and other layered configurations may be utilized in accordance with the teachings herein without departing from the spirit and scope of the present invention. By providing both cushioning and absorbent layers in the mat, the mat will absorb liquid while, at the same time, maintaining its shock absorption properties. Preferably, the cushioning layer is liquid impermeable and, thus, even once the absorbent layer of the mat becomes saturated with liquid, the mat will still maintain its shock absorption properties. Thus, the inventive anti-fatigue mat simultaneously serves a dual absorbent/cushioning purpose, without sacrificing one for the other.

While the present invention has been described with particular reference to the drawings, it should be understood that various modification could be made without departing from the spirit and scope of the present invention.

We claim:

1. A mat for absorbing liquids, the mat comprising:
a first layer of absorbent material having top and bottom surfaces, the first layer of absorbent material having liquid absorbent properties; and
a first layer of cushioning material attached to the bottom surface of the first layer of absorbent material, the first layer of cushioning material being liquid impermeable and having shock absorption properties.

2. The mat of claim 1, further comprising a first layer of wear-resistant material attached to the top surface of the first layer of absorbent material.

3. The mat of claim 1, wherein the first layer of cushioning material has an exposed surface having an adhesive material thereon for adhering the mat to a surface.

4. The mat of claim 3, wherein the adhesive material comprises double-sided tape.

5. The mat of claim 1, wherein the top surface of the first layer of absorbent material includes wear-resistant properties.

6. The mat of claim 1, wherein the first layer of absorbent material is selected from the group consisting of woven liquid absorbing fabrics, nonwoven liquid absorbing fabrics, and meltblown microfibrous materials.

7. The mat of claim 1, wherein the first layer of cushioning material comprises a first layer of bubble wrap having a plurality of air pockets.

8. The mat of claim 7, wherein the plurality of air pockets are filled with a material selected from the group consisting of resilient materials, gelatinous materials, viscous materials and non-compressible liquids.

9. The mat of claim 1, wherein the mat is in the form of a long strip with two substantially parallel edges, and wherein the long strip is provided with perforations extending substantially perpendicular to the strip edges enabling (a) the long strip to be torn apart along the perforations into individual mats, and (b) the long strip to be folded along the perforations.

10. The mat of claim 1, further comprising a second layer of cushioning material attached to the first layer of cushioning material, the second layer of cushioning material being liquid impermeable and having shock absorption properties.

11. The mat of claim 10, wherein the second layer of cushioning material has an exposed surface having an adhesive material thereon for adhering the mat to a surface.

12. The mat of claim 10, wherein the first and second layers of cushioning material comprise first and second layers of bubble wrap, respectively, each having a plurality of air pockets.

13. The mat of claim 12, wherein the plurality of air pockets of at least one of the first and second layers of bubble wrap are filled with a material selected from the group consisting of resilient materials, gelatinous materials, viscous materials and non-compressible liquids.

14. The mat of claim 10, further comprising a second layer of absorbent material attached to the second layer of cushioning material, the second layer of absorbent material having top and bottom surfaces, with the bottom surface of the second layer of absorbent material attached to the second layer of cushioning material.

15. The mat of claim 14, wherein at least one of the first and second layers of absorbent material are selected from the group consisting of woven liquid absorbing fabrics, nonwoven liquid absorbing fabrics, and meltblown microfibrous materials.

16. The mat of claim 14, wherein at least one of the top, exposed surfaces of the first and second layers of absorbent material include a layer of wear-resistant material attached thereto.

17. The mat of claim 1, further comprising a second layer of absorbent material attached to the first layer of cushioning material, the second layer of absorbent material having top and bottom surfaces, with the bottom surface of the second layer of absorbent material attached to the first layer of cushioning material.

18. The mat of claim 17, wherein at least one of the first and second layers of absorbent material are selected from the group consisting of woven liquid absorbing fabrics, nonwoven liquid absorbing fabrics, and meltblown microfibrous materials.

19. The mat of claim 17, wherein at least one of the top, exposed surfaces of the first and second layers of absorbent material include a layer of wear-resistant material attached thereto.

20. The mat of claim 1, provided in combination with a tray member having ramped peripheral edges defining a receptacle, wherein the receptacle and the mat are similarly geometrically shaped such that the mat is placeable in the receptacle and substantially prevented from sliding movement therein.

21. A mat for absorbing liquids, the mat comprising:
a layer of absorbent material having top and bottom surfaces, the layer of absorbent material selected from the group consisting of woven liquid absorbing fabrics, nonwoven liquid absorbing fabrics, and meltblown microfibrous materials; and
a layer of cushioning material having shock absorption properties attached to the bottom surface of the layer of absorbent material, the layer of cushioning material comprising a layer of bubble wrap having a plurality of air pockets.

22. The mat of claim 21, further comprising a layer of wear-resistant material attached to the top surface of the layer of absorbent material.

23. The mat of claim 21, provided in combination with a tray member having ramped peripheral edges defining a receptacle, wherein the receptacle and the mat are similarly geometrically shaped such that the mat is placeable in the receptacle and substantially prevented from sliding movement therein.

24. The mat of claim 21, wherein the layer of bubble wrap includes an exposed surface having an adhesive material thereon for adhering the mat to a surface.

25. A mat for absorbing liquids, the mat comprising:
first and second layers of absorbent material attached face-to-face at all but one edge thereof to define a pocket having an open end; and
a layer of cushioning material having shock absorption properties removably insertable into the pocket.

26. The mat of claim 25, further comprising first and second layers of wear-resistant material attached to exposed surfaces of the first and second layers of absorbent material, respectively.

27. The mat of claim 25, wherein the first and second layers of absorbent material are selected from the group consisting of woven liquid absorbing fabrics, nonwoven liquid absorbing fabrics, and meltblown microfibrous materials.

28. The mat of claim 25, wherein the layer of cushioning material comprises a layer of bubble wrap having a plurality of air pockets.
